(19) United States
(12) Patent Application Publication
(10) Pub. No.: US 2026/0330860 A1
(43) Pub. Date: Oct. 22, 2026

(54) ARTIFICIAL INTELLIGENCE BASED METHOD AND SYSTEM FOR IDENTIFYING FORMULA HANDWRITTEN ON WHITEBOARD IN REAL TIME

(71) Applicant: GuangZhou Dazzle View Intelligent Technology Co., Ltd., Guangzhou City (CN)

(72) Inventors: Bin DAI, Guangzhou City (CN); Zhentao WU, Guangzhou City (CN)

(21) Appl. No.: 19/654,450

(22) Filed: Apr. 22, 2026

(30) Foreign Application Priority Data
Apr. 22, 2025 (CN) 2025105093212

(51) Int. Cl. G06V 30/19; G06V 30/32

(52) U.S. Cl. CPC G06V 30/1918; G06V 30/19173; G06V 30/347

(57) ABSTRACT

The present disclosure relates to the technical field of smart whiteboards, and particularly relates to an artificial intelligence based method and system for identifying a formula handwritten on a whiteboard in real time. The method includes the following steps: constructing a handwriting path trajectory based on a touch point sequence, and delineating a high-density handwriting zone; performing symbol detection on the high-density handwriting zone to locate a potential symbol zone, and extracting a stroke feature vector of the potential symbol zone through a MobileNet Version 3 Small (MobileNetV3-Small) model; fusing the stroke feature vector with handwriting pressure and a feature of an inclination angle, and constructing a symbolic relationship graph; and dynamically planning, based on a node feature and a dynamic adjacency matrix in the symbolic relationship graph, an initial LaTeX sequence through a Cocke-Younger-Kasami (CYK) algorithm, and transforming the symbolic relationship graph into a LaTeX expression.

### CROSS-REFERENCE TO RELATED APPLICATIONS

This application claims priority to Chinese Patent Application No. 202510509321.2, filed on Apr. 22, 2025, the content of which is incorporated herein by reference in its entirety.

### TECHNICAL FIELD

The present disclosure relates to the technical field of smart whiteboards, and particularly relates to an artificial intelligence based method and system for identifying a formula handwritten on a whiteboard in real time.

### BACKGROUND

An artificial intelligence whiteboard is an interactive writing platform integrating the artificial intelligence technology. It can perceive, analyze and process handwriting input of a user in real time. In classroom or distance teaching, the whiteboard is configured to write mathematical formulas, physical equations, etc., and a system performs real-time identification to generate standard LaTeX codes or visual mathematical expressions. However, during writing of complex formulas, missing or false detection frequently occurs in dense writing zones, and abilities to distinguish similar symbols are generally insufficient.

Meanwhile, during quick writing, the system has an identification delay due to the limitation of computing power, thus failing to reconstruct a consecutive path in time. In view of this, an artificial intelligence based method and system for identifying a formula handwritten on a whiteboard in real time are provided.

### SUMMARY

An objective of the present disclosure is to provide an artificial intelligence based method and system for identifying a formula handwritten on a whiteboard in real time, so as to solve the problems that during writing of complex formulas, missing or false detection frequently occurs in dense writing zones, and abilities to distinguish similar symbols are generally insufficient in the background art.

To achieve the above objective, the present disclosure provides an artificial intelligence based method for identifying a formula handwritten on a whiteboard in real time. The method includes the following steps:
S1, capturing a touch point sequence input by a user through an artificial intelligence whiteboard, constructing a handwriting path trajectory rᵢ(t) based on the touch point sequence, and delineating a high-density handwriting zone;
S2, performing symbol detection on the high-density handwriting zone to locate a potential symbol zone, and extracting a stroke feature vector vₙₒᵣₘ of the potential symbol zone through a MobileNet Version 3 Small (MobileNetV3-Small) model;
S3, fusing the extracted stroke feature vector vₙₒᵣₘ with handwriting pressure pₘ and a feature of an inclination angle θₘ, constructing a symbolic relationship graph, and dynamically correcting a node connection weight of the symbolic relationship graph through Transformer combined with a multi-layer perceptron (MLP) classification device, which is configured to construct a two-dimensional spatial relationship of superscripts and subscripts, fractions, and integral structures; and
S4, generating, based on a node feature and a dynamic adjacency matrix in the symbolic relationship graph, an initial LaTeX sequence through a Transformer decoder, dynamically planning the initial LaTeX sequence through a Cocke-Younger-Kasami (CYK) algorithm, and transforming the symbolic relationship graph into a LaTeX expression.

As a further improvement of the technical solution, in S1, specific steps of the delineating a high-density handwriting zone are as follows:
S1.1, combining the handwriting pressure pₘ and the inclination angle θₘ, and discretizing the handwriting path trajectory rᵢ(t) into a dense point sequence

$${q}_{m}^{( i )} ;$$

S1.2, merging an original touch point sequence S and the dense point sequence

$${q}_{m}^{( i )} ,$$

generating an enhanced point set S′, and computing a grid density Nᵢⱼ; and
S1.3, performing dynamic threshold segmentation on the grid density Nᵢⱼ, and delineating the high-density handwriting zone.

As a further improvement of the technical solution, in S1.3, specific steps of the delineating the high-density handwriting zone are as follows:
counting a global density average u of all non-empty grid cells Gᵢⱼ;
computing a standard deviation σ of density distribution based on the global density average μ;
using a linear combination of the global density average μ and the standard deviation σ as a dynamic density threshold θ;
traversing all the grid cells Gᵢⱼ, labeling, if Nᵢⱼ≥θ, the grid cells Gᵢⱼ as high-density zones, and generating a candidate set [symbol] ={Gᵢⱼ|Nᵢⱼ≥θ};
modeling the high-density candidate set [symbol] as a graph G;
traversing the graph G based on a breadth-first search algorithm, and merging adjacent high-density grids into connected zones [symbol] ; and
repeating a process of traversing the graph G through the breadth-first search algorithm, wherein each time of the process starts from an unprocessed starting point to generate a new connected zone, repeating the process until all the high-density grids are accessed, and finally generating m independent high-density handwriting zone sets K.

As a further improvement of the technical solution, in S2, specific steps of the performing symbol detection on the high-density handwriting zone to locate a potential symbol zone are as follows:
computing center coordinates (x_{c}, y_{c}) and a width and height (w, h) of a circumscribed rectangle of each of the connected zones [symbol] in the high-density handwriting zone set K, and generating a multi-scale candidate box set

$$\{ {B}_{ℓ}^{( s )} \} ;$$

using the multi-scale candidate box set

$$\{ {B}_{ℓ}^{( s )} \}$$

as input of You Only Look Once Version 8 Nano (YOLOv8-Nano), and outputting initial detection boxes through the YOLOv8-Nano;
sorting the initial detection boxes in descending order according to confidence, and obtaining an ordered list {Bₖ};
computing an average \hat{N}ᵢ of a grid density covered by each of the detection boxes Bᵢ as follows:

$${\overline{N}}_{i} = \frac{1}{\vert {G}_{ij} ⋂ {B}_{i} \vert} {Σ}_{{G}_{ij} ∈ {B}_{i}} {N}_{ij} ,$$

where
in the formula, Gᵢⱼ denotes the grid cells into which an image is divided; Bᵢ denotes an i-th initial detection box; and Ny denotes a density value of the grid cells Gᵢⱼ;
using a ratio of a local density average N̅ᵢ to the global density average μ as a non-maximum suppression (NMS) threshold adjustment factor, initializing an NMS threshold τ₀ based on the NMS threshold adjustment factor, and generating a dynamic NMS threshold τᵢ, where the dynamic threshold is

$${τ}_{i} = {τ}_{0} \cdot \frac{{\overline{N}}_{i}}{μ} ,$$

μ denotes the global density average; and in the formula, τᵢ denotes the dynamically adjusted NMS threshold;
retaining, if an intersection of union of a detection box B; and a detection box Bⱼ is IoU(Bᵢ, Bⱼ)>τᵢ, the detection box having a higher density average, deleting the other box, and repeating the step until all candidate boxes are processed; and preferentially retaining detection results of the high-density zones; and
constructing a feature pyramid network in MobileNetV3-Small, performing multi-scale symbol feature extraction on the detection boxes in the high-density zones through the feature pyramid network, and outputting a final symbol position and category.

As a further improvement of the technical solution, in S2, specific steps of the extracting a stroke feature vector of the potential symbol zone through a MobileNetV3-Small model are as follows:
cutting a symbol zone I_{crop} from an original image according to detection box coordinates (x, y, w, h), and preprocessing I_{crop} to obtain Iᵢₙₚᵤₜ;
introducing a deformable convolution into a Bottleneck layer of the MobileNetV3-Small, dynamically learning an offset Δₚ_{ₖ} and a direction angle θₖ of a convolutional kernel, and obtaining a feature map F_{deform} of an adaptive stroke direction;
inputting the feature map F_{deform} as a local stroke attention device of the MobileNetV3-Small, adding a stroke direction weight Aₛₜᵣₒₖₑ to the local stroke attention device, and obtaining a feature map Fₐₜₜ of a key stroke zone, which is configured to strengthen a feature response of the key stroke zone (such as an intersection point and an end point);
performing cross-level feature fusion on feature maps extracted from different Bottleneck layers, and obtaining a fused multi-scale feature map F_{fuse}; and
performing dimensionality reduction on the multi-scale feature map F_{fuse}, and generating the stroke feature vector vₙₒᵣₘ.

As a further improvement of the technical solution, in S3, specific steps involved in constructing the symbolic relationship graph through the stroke feature vector vₙₒᵣₘ are as follows:
fusing the handwriting pressure pₘ and the feature of the inclination angle θₘ with the stroke feature vector vₙₒᵣₘ, and obtaining the fused stroke feature vector v′ₙₒᵣₘ;
initializing an importance weight w_{c} for the handwriting pressure pₘ;
discretizing the inclination angle θₘ into 8-direction codes φᵢ∈ [symbol] ;
computing, for any two nodes, a center distance dᵢⱼ between circumscribed rectangles of the two nodes, and defining a dynamic adjacency threshold yᵢⱼ:

$${γ}_{ij} = α \cdot max ( {w}_{i} , {h}_{i} , {w}_{j} , {h}_{j} ) + β \cdot ( 1 - sim ( {v}_{norm}^{′ ( i )} , {v}_{norm}^{′ ( j )} ) )$$

in the formula, yᵢⱼ denotes the dynamic adjacency threshold of a node pair i and j; α denotes a weight coefficient for balancing spatial scale influence; β denotes a weight coefficient for balancing feature difference influence; sin(*) denotes cosine similarity; wᵢ denotes a width of a circumscribed rectangle of an i-th node; hᵢ denotes a height of the circumscribed rectangle of the i-thnode; wⱼ denotes a width of a circumscribed rectangle of a j-th node; and hⱼ denotes a height of the circumscribed rectangle of the j-th node;
computing an inclination angle difference Δθᵢⱼ of the inclination angle θₘ;
initializing, based on the fused stroke feature vector v′ₙₒᵣₘ the direction codes φᵢ and the inclination angle difference Δθᵢⱼ, an edge weight

$${w}_{ij}^{( 0 )}$$

of each pair of connection nodes (i, j); and
collecting the edge weights of all the nodes (i, j), and constructing an adjacency matrix W of N×N.

As a further improvement of the technical solution, specific steps of the dynamically correcting a node connection weight of the symbolic relationship graph through Transformer combined with an MLP classification device are as follows:
performing, before constructing the adjacency matrix W, self-attention encoding on the stroke feature vector v′ₙₒᵣₘ based on a Transformer encoder, and obtaining a context-sensitive expression zᵢ;
constructing a joint feature vector hᵢⱼ for any node pair (i, j);
introducing the MLP classification device to classify the joint feature vectors hᵢⱼ, and predicting a correction factor τᵢⱼ; and
updating the dynamic adjacency threshold yᵢⱼ based on the correction factor τᵢⱼ, and finally determining whether to establish a connection in the adjacency matrix W according to the updated dynamic adjacency threshold

$${γ}_{ij}^{*} .$$

As a further improvement of the technical solution, S4 includes: predicting, for each node vᵢ in the symbolic relationship graph, a syntactic role rᵢ is based on a multi-layer perceptron;
constructing, based on the final adjacency matrix W and the syntactic role rᵢ, a syntax structure tree;
encoding the syntax structure tree from bottom to top through a tree-structured long short-term memory;
generating, by the Transformer decoder, a LaTeX sequence through an autoregressive method, where each step predicts a next Token based on syntax tree encoding and an attention mechanism;
introducing, in a decoding process of the Transformer decoder, relative position codes between symbols to adjust attention scores; and
dynamically planning the initial LaTeX sequence through the CYK algorithm, and transforming the symbolic relationship graph into the LaTeX expression.
In addition, the present disclosure provides an artificial intelligence based system for identifying a formula handwritten on a whiteboard in real time. The system includes a memory, a processor, and a computer program stored in the memory and runnable on the processor. The processor executes the computer program to implement the steps of the artificial intelligence based method for identifying a formula handwritten on a whiteboard in real time according to any one of the examples.

Compared with the prior art, the present disclosure has the beneficial effects:
1, in the artificial intelligence based method and system for identifying a formula handwritten on a whiteboard in real time, through dynamic threshold segmentation combined with the handwriting pressure and inclination angle information, by dynamically adjusting a sampling density and the NMS threshold, detection results of the high-density zones are preferably retained. Moreover, a response of a key zone is enhanced by combining a stroke direction feature, such that accuracy of symbol detection is significantly improved, and problems that conventional methods are prone to missing or false detection in dense writing zones and have insufficient abilities to distinguish similar symbols are solved.
2, in the artificial intelligence based method and system for identifying a formula handwritten on a whiteboard in real time, a stroke feature, pressure and the inclination angle are synchronously fused when the symbolic relationship graph is constructed, and relative positions and directions between symbols are accurately modeled through the dynamic adjacency threshold and context-sensitive weight correction. In this way, accuracy of the syntax structure tree is improved, and a problem that the conventional methods can hardly effectively capture a spatial relationship of superscripts and subscripts, fractions, integrals and other structures is solved.
3, in the artificial intelligence based method and system for identifying a formula handwritten on a whiteboard in real time, based on the CYK algorithm combined with a symbolic spatial score function, by enhancing Transformer decoding through relative position encoding, geometric constraints such as a spatial distance and a direction angle are integrated into a syntax rule. An optimal parse tree is generated through dynamic planning to ensure strict correspondence between LaTeX expressions and handwritten formulas.

Meanwhile, through a lightweight network design and a parallel architecture, a central processing unit/graphics processing unit (CPU/GPU) load is significantly reduced while accuracy is ensured, which is suitable for low-power scenes of smart whiteboards.

### BRIEF DESCRIPTION OF THE DRAWINGS

FIG. 1 is an overall flowchart of a method of the present disclosure.

### DETAILED DESCRIPTION OF THE EMBODIMENTS

Technical solutions in embodiments of the present disclosure will be clearly and completely described below with reference to accompanying drawings in the embodiments of the present disclosure. Obviously, the embodiments described are merely some embodiments rather than all embodiments of the present disclosure. All other embodiments obtained by those of ordinary skill in the art based on the embodiments of the present disclosure without creative efforts shall fall within the protection scope of the present disclosure.

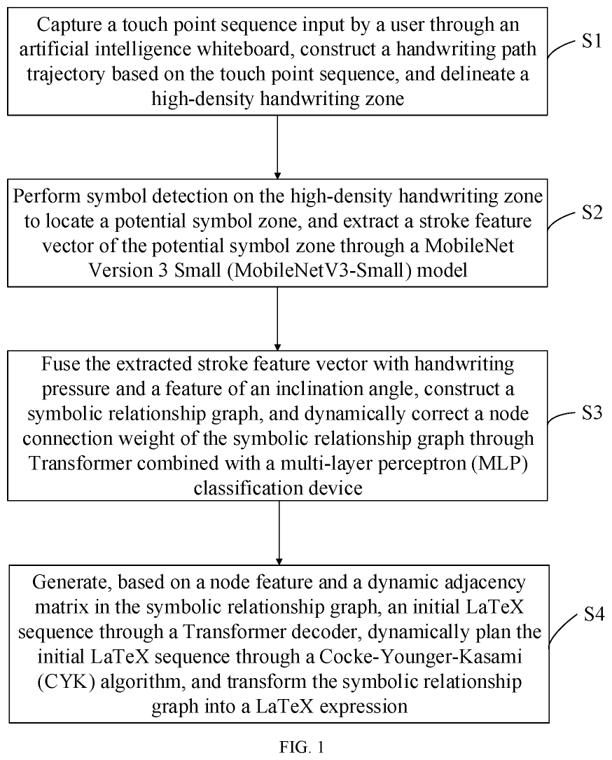

Embodiment 1: With reference to FIG. 1, the embodiment provides an
artificial intelligence based method for identifying a formula handwritten on a whiteboard in real time. The method includes the following steps:
S1, a touch point sequence input by a user is captured through an artificial intelligence whiteboard, a handwriting trajectory is constructed, and a high-density handwriting zone is delineated.

Specifically, in the embodiment, the artificial intelligence whiteboard records input of the user in a form of time stamps and coordinate points. The artificial intelligence whiteboard is equipped with an intelligent interaction device, an image processing device and an artificial intelligence (AI) computation device. A terminal of the artificial intelligence whiteboard captures the touch point sequence input by the user on a writing surface of the whiteboard through a built-in capacitance/electromagnetic touch module at a high frequency of 100 Hz. Thus, the touch point sequence S is a data stream including time and coordinates, and the touch point sequence S is specifically as follows:

$$S = {\{ {p}_{k} \vert {p}_{k} = ( {x}_{k} , {y}_{k} , {t}_{k} ) \}}_{k = 1}^{n}$$

In the formula, xₖ, yₖ∈ [symbol] denotes coordinates of a coordinate system of the artificial intelligence whiteboard; tₖ denotes a time stamp of a k-th touch point, and satisfies tₖ₊₁−tₖ≤Δtₘₐₓ; and n denotes a total quantity of touch points in a single stroke.

The touch point sequence S captures a writing action of the user through high-frequency sampling (at 100 Hz) to ensure that a point density is consistent with that of real handwriting.

Then, specific steps involved in the step that the handwriting path trajectory rᵢ(t) is constructed based on the touch point sequence S are as follows:

Gaussian filtering noise reduction is performed on the original touch point sequence S, to eliminate jitter noise of a touch screen and generate a smooth touch point sequence \tilde{S}.

In the step,

$${\tilde{p}}_{k} = {\sum }_{m = k - 2}^{k + 2} {p}_{m} \cdot \frac{1}{\sqrt{2 π} σ} {e}^{- \frac{{( m - k )}^{2}}{2 {σ}^{2}}}$$

$$and$$

$$σ = 1.2 .$$

In the formula, \tilde{p}ₖ denotes a k-th touch point after filtering; pₘ denotes an m-th point in the original touch point sequence S; m denotes a summation variable, and represents a traversal range of a touch point index; σ denotes a standard deviation of a Gaussian function;

$$\frac{1}{\sqrt{2 π} σ}$$

denotes a normalization coefficient of the Gaussian function; and

$${e}^{- \frac{{( m - k )}^{2}}{2 {σ}^{2}}}$$

denotes an exponential decay term of a Gaussian kernel.

Because large-scale interpolation may increase a central processing unit (CPU) load, a Catmull-Rom interpolation algorithm with dynamic density control is used to prevent the excessive CPU load as follows:

An adaptive adjustment strategy of an interpolation step size is defined as follows:

$$δ {t}_{k} = min ( δ {t}_{base} , {a}^{′} \cdot \frac{‖ {\tilde{p}}_{k + 1} - {\tilde{p}}_{k} ‖}{{v}_{avg}} )$$

In the formula, δt_{base}=0.01 S denotes a reference interpolation interval;

$${v}_{avg} = \frac{1}{n - 1} {Σ}_{k = 1}^{n - 1} \frac{‖ {\tilde{p}}_{k + 1} - {\tilde{p}}_{k} ‖}{{t}_{k + 1} - {t}_{k}}$$

represents an average writing speed; a′=0.6 represents a speed sensitivity coefficient; δtₖ denotes an interpolation step size of a k-th touch point; and k denotes an index variable.

The adaptive adjustment strategy of the interpolation step size is configured to reduce an interpolation density in a high-speed writing zone and increase an interpolation density in a low-speed zone, thus achieving dynamic balance of a computing load.

An independent spline segment is constructed for every four continuous touch points {\tilde{p}ₖ₋₁, \tilde{p}ₖ, \tilde{p}ₖ₊₁, \tilde{p}ₖ₊₂} as follows:

$${r}_{i} ( t ) = \{ \begin{matrix}{\sum }_{i = 0}^{3} {B}_{i} ( s ) \cdot {\tilde{p}}_{k - 1 + i} , t ∈ [ {t}_{k} , {t}_{k + 1} ] \\ null , other intervals\end{matrix}$$

In the formula, Bᵢ(s) denotes a Catmull-Rom basis function (cubic polynomial).

$$s = \frac{t - {t}_{k}}{{t}_{k + 1} - {t}_{k}} ∈ [ {t}_{k} , 1 ]$$

denotes a normalized time parameter; and rᵢ(t) denotes a k-th independent spline segment constructed by four continuous touch points {\tilde{p}ₖ₋₁, \tilde{p}ₖ, \tilde{p}ₖ₊₁, \tilde{p}ₖ₊₂}.

Interpolation computation of each segment is independent of each other and satisfies a parallelization condition.

Further, a parallel computing architecture is used to implement real-time interpolation computation, to reduce computation time.

Specifically, the touch point sequence is divided into

$$m = \frac{⌊ n - 1 ⌋}{3}$$

processing units, and each unit includes 4 continuous touch points, which are assigned to independent computing threads.

A compute shader is configured to perform interpolation operation in parallel, and real-time interpolation computation is implemented through a graphics processing unit (GPU) parallel pipeline.

Meanwhile, a continuity constraint is imposed on a segment connection t=tₖ₊₁, and connection discontinuity caused by parallel segmentation is eliminated by constraining continuity of a first-order derivative of adjacent segments as follows:

The continuity constraint is specifically as follows:

$${{\frac{{dr}_{k}}{dt} \vert}_{t = {t}_{k + 1}^{-}} = \frac{{dr}_{k + 1}}{dt} \vert}_{t = {t}_{k + 1}^{+}}$$

In the formula,

$${\frac{{dr}_{k}}{dt} \vert}_{t = {t}_{k + 1}^{-}}$$

denotes a left-hand derivative of a spline segment rₖ(t) at a moment tₖ₊₁; and

$${\frac{{dr}_{k + 1}}{dt} \vert}_{t = {t}_{k + 1}^{+}}$$

denotes a right-hand derivative of a spline segment rₖ₊₁(t) at a moment tₖ₊₁.

A circular buffer is constructed to store interpolation results of adjacent segments, and a double buffering technology is used to implement lock-free data synchronization, so as to ensure temporal and spatial continuity of trajectory output.

In the embodiment, specific steps of the step that the high-density handwriting zone is delineated are as follows:
S1.1, the handwriting pressure pₘ and the inclination angle θₘ are combined, and the handwriting path trajectory rᵢ(t) is discretized into a dense point sequence

$${q}_{m}^{( i )}$$

as follows:

For a trajectory point

$${q}_{m}^{( i )} = ( {x}_{m} , {y}_{m} )$$

generated by interpolation, corresponding handwriting pressure is pₘ and an corresponding inclination angle is θₘ·(xₘ, yₘ) denotes coordinates of the trajectory point, and is computed by an interpolation algorithm, and

$${q}_{m}^{( i )}$$

denotes a coordinate value of an m-th sampling point on an i-th spline segment.

When each spline segment is sampled discretely, a trajectory point

$${q}_{m}^{( i )} = ( {x}_{m} , {y}_{m} )$$

generated by interpolation is a value of a function rᵢ(t) at time tₘ.

Sampling is performed with a step size Δtₘ on a normalized time parameter S, to obtain a dense point sequence

$${q}_{m}^{( i )}$$

as follows:

$${q}_{m}^{( i )} = ( {r}_{i} ( {t}_{k} + m \cdot Δ {t}_{m} ) , {p}_{m} , {θ}_{m} ) , and m = 0 , 1 , … , ⌊ \frac{{t}_{k + 1} - {t}_{k}}{Δ {t}_{m}} ⌋ .$$

In the formula, tₖ denotes start time of a spline segment i; tₖ₊₁ denotes end time of the spline segment; Δtₘ denotes a sampling time interval; and

$$⌊ \frac{{t}_{k + 1} - {t}_{k}}{Δ {t}_{m}} ⌋$$

denotes a quantity of sampling points of the spline segment.

A sampling density is dynamically adjusted through the handwriting pressure pₘ and the inclination angle θₘ to preserve handwriting details.

All sampling points of spline segments are merged into a discrete point sequence.

$$\{ {\tilde{q}}_{m}^{( i )} \} = {⋃}_{i = 1}^{o} \{ {q}_{0}^{( i )} , {q}_{1}^{( i )} , … , {q}_{{M}_{i}}^{( i )} \}$$

In the formula, o denotes a total quantity of spline segments;

$$\{ {\tilde{q}}_{m}^{( i )} \}$$

denotes a set of all discretized point sequences;

$${q}_{{M}_{i}}^{( i )}$$

denotes a last discrete sampling point of an i-th spline segment; Mᵢ denotes a quantity of sampling points on the i-th spline segment minus 1. If a spline segment is discretized into 5 points, Mᵢ=4, and an index is 0, 1, 2, 3, and 4.

Further, the handwriting pressure may reflect a stroke magnitude, and the inclination angle may indicate a writing direction. By integrating the physical features, a system can more accurately distinguish symbols having similar visual forms and different writing dynamics. A stroke with higher pressure may correspond to start of a bold symbol or an integral symbol, and a change of an inclination angle can distinguish a fraction bar (a horizontal inclination angle) from an italic letter (inclination).

$${q}_{m}^{( i )}$$

S1.2, an original touch point sequence S and the dense point sequence are merged, an enhanced point set S′ is generated, and a grid density Nᵢⱼ is computed.

The original touch point sequence S is specifically as follows:

$$S = {\{ {p}_{k} \vert {p}_{k} = ( {x}_{k} , {y}_{k} , {t}_{k} ) \}}_{k = 1}^{n} .$$

A trajectory point sequence generated through an interpolation algorithm (cubic spline interpolation) as follows:

$${q}_{m}^{( i )} = ( {x}_{m} , {y}_{m} , {t}_{m} , {p}_{m} , {θ}_{m} )$$

In the formula, xₘ denotes an abscissa after interpolation; yₘ denotes an ordinate after interpolation; tₘ denotes a pressure value after interpolation; pₖ denotes a k-th original touch point; xₖ denotes an abscissa of the -th original touch point; yₖ denotes an ordinate of the k-th original touch point; tₖ denotes a time stamp of the k-th original touch point; Om denotes an inclination angle (an inclination angle of a pen, also configured for dynamic sampling) of an interpolation point; k denotes an index variable; and n denotes a total quantity of original touch points.

Thus, the enhanced point set S′ is as follows:

$${S}^{′} = S ⋃ {⋃}_{i} {\{ {q}_{m}^{( i )} \}}_{m = 0}^{{M}_{i}}$$

In the formula,

$$\{ {q}_{m}^{( i )} \}$$

denotes a set of all dense point sequences;

$${M}_{i} = \frac{{t}_{k + 1} - {t}_{k}}{Δ {t}_{m}} ,$$

and Δtₘ denotes a sampling time step size after dynamic adjustment; and tₖ denotes a time stamp of a k-th point in the original touch point sequence S.

In the embodiment, the point density is raised to 400 dpi through secondary sampling, and spatial resolution of each grid cell is aligned with a target point density of 400 dpi.

Further, a quantified grid is defined as

Gᵢⱼ=[i·Δx, (i+1)·Δx]×[j·Δy, (j+1)Δy].

In the formula,

$$Δ x = Δ y = \frac{1}{400}$$

inch, which represents a physical size of a grid cell; i, j∈ [symbol] denotes a grid index, and covers an effective writing zone of the whiteboard; Δx denotes a width of the grid cell; Δy denotes a height of the grid cell; i denotes a row index (in an x axis direction) of the grid, and covers the effective writing zone; and j denotes a row index (in a y axis direction) of the grid, and covers the effective writing zone.

Then, for each grid cell Gᵢⱼ, a coverage frequency of a touch point is computed:

For each point p=(x, y, t, pₘ, θₘ) in the enhanced point set S′, the grid cell Gᵢⱼ is divided according to:

$$i = 1 ⌊ \frac{λ}{Δ x} ⌋ , and j = ⌊ \frac{y}{Δ y} ⌋ .$$

In the formulas, t denotes a time stamp.

The grid density Nᵢⱼ is defined as a quantity of points falling within the grid cell Gᵢⱼ as follows:

$${N}_{ij} = {Σ}_{p ∈ {S}^{′}}^{n} {1}_{\{ ( {p}_{x} , {p}_{y} ) ∈ {G}_{ij} \}}$$

In the formula, 1_{{*}} denotes an indicator function, and a frequency of a touch point falling into the grid is counted; when (pₓ, p_{y}) belongs to Gᵢⱼ, a value is 1, otherwise, the value is 0; and (pₓ, p_{y}) denotes a coordinate component of a point p; and n denotes a total quantity of points.

By counting a distribution of the grid density Nᵢⱼ, whether the touch points are evenly covered or there are blind spots is detected.
S1.3, dynamic threshold segmentation is performed on the grid density Nᵢⱼ, and the high-density handwriting zone is delineated.

A dynamic density threshold θ of the high-density handwriting zone is defined as follows:

θ=μ+aσ

For a grid cell Gᵢⱼ, a global density average μ is counted as follows:

$$μ = \frac{1}{M \cdot N} {Σ}_{i = 1}^{M} {Σ}_{j = 1}^{N} {N}_{ij}$$

$$σ = \sqrt{\frac{1}{M \cdot N} {Σ}_{i = 1}^{M} {{Σ}_{j = 1}^{N} ( {N}_{ij} - μ )}^{2}}$$

M×N denotes a total quantity of rows and columns of the quantified grid; and Nᵢⱼ denotes a density value of the grid cell Gᵢⱼ.

In the formulas, a denotes an adjustment coefficient, an empirical value range is α∈[1, 2], and is configured to dynamically adapt to fluctuations of a writing density, and a value of a is adjusted through fast writing (with a low density) and fine writing (with a high density); μ denotes the global density average, and represents an average density of all grid cells; σ denotes a global density standard deviation, and is configured to measure a dispersion degree of the grid density; M denotes a total quantity of the quantified grid (a quantity of grid cells divided horizontally); N denotes a total quantity of columns in the quantified grid (a quantity of grid cells divided vertically); Nᵢⱼ denotes a point density in the grid cell Gᵢⱼ (i.e. a total quantity of touch points and interpolation points falling into the grid); Gᵢⱼ denotes the grid cell in an i-th row and a j-th column in a two-dimensional quantified grid.

All the grid cells Gᵢⱼ are traversed, to determine whether the grid cells are the high-density zones.

If Nᵢⱼ≥θ, the grid cells Gᵢⱼ are labeled as high-density cells to constitute a candidate set [symbol] ={Gᵢⱼ|Nᵢⱼ≥θ}.

A graph model is constructed as follows:

The high-density candidate set [symbol] is modeled as a graph G=(V, E), where a vertex set satisfies V= [symbol] , and an edge set E denotes a relationship between adjacent grids (using a 8-neighborhood connection rule). If two grid cells are adjacent (share edges or corners) in 8 neighborhoods, there are edges between the corresponding vertices.

The graph G is traversed based on a breadth-first search (BFS) algorithm, and adjacent high-density grids are merged into connected zones [symbol] as follows:

[symbol]

= [symbol] , Gᵢⱼ

[symbol] denotes an [symbol] - [symbol] connected component and includes an index set (i, j) of all grid cells belonging to the same connected zone; [symbol] denotes an [symbol] -th independent high-density handwriting zone, and is generated by merging all grid cells in the connected component [symbol] ; and [symbol] denotes a serial number index of the connected component.

A process of traversing the graph G through the breadth-first search (BFS) algorithm is repeated. Each time of the process starts from an unprocessed starting point to generate a new connected zone. The process is repeated until all the high-density grids are accessed. m independent high-density handwriting zone sets K are finally obtained. K=(R₁, R₂, . . . , Rₘ}, which provides input for subsequent formula identification, and each zone represents a connected block of high-density handwriting.

K denotes a finally output independent high-density zone set; m denotes a total quantity of independent high-density zones (i.e. a quantity of connected components); and Km denotes an m-th independent high-density handwriting zone K.
S2, symbol detection is performed on the high-density handwriting zone through You Only Look Once Version 8 Nano (YOLOv8-Nano) to locate a potential symbol zone, and a stroke feature vector of the potential symbol zone is extracted through a MobileNet Version 3 Small (MobileNetV3-Small) model; the terminal of the artificial intelligence whiteboard invokes a built-in lightweight target detection device, the YOLOv8-Nano is used as the core, and a multi-scale candidate box is generated for each connected zone in the high-density handwriting zone set K, and is input into the YOLOV8 Nano to output an initial detection box; and after sorting based on confidence, an average grid density covered by the detection boxes is computed, a dynamic non-maximum suppression (NMS) threshold is generated through a ratio of a local density average to the global density average, detection results of the high-density zones are preferably retained, and the potential symbol zone is accurately located.

Specifically, specific steps of the step that symbol detection is performed on the high-density handwriting zone to locate the potential symbol zone are as follows:

Center coordinates (x_{c}, y_{c}) and a width and height (w, h) of a circumscribed rectangle of each of the connected zones [symbol] n the high-density handwriting zone set K are computed.

A multi-scale candidate box set

$$\{ {B}_{ℓ}^{( s )} \}$$

is generated, where a scale factor satisfies s∈(0.5, 1.0, 1.5}, and coordinates of the candidate box are as follows:

$${B}_{ℓ}^{( s )} = ( {x}_{c} - \frac{s \cdot w}{2} , {y}_{c} - \frac{s \cdot h}{2} , {x}_{c} + \frac{s \cdot w}{2} , {y}_{c} + \frac{s \cdot h}{2} )$$

In the formula, x_{c} denotes a central abscissa of a connected zone [symbol] ; y_{c} denotes a central ordinate of the connected zone [symbol] ; s denotes the scale factor; w denotes a width of a circumscribed rectangle of the connected zone [symbol] ; h denotes a height of the circumscribed rectangle of the connected zone [symbol] ; and

$${B}_{ℓ}^{( s )}$$

denotes a candidate box of an s-th scale generated based on the connected zone [symbol] .

The candidate box is input into a YOLOv8-Nano network, and the initial detection box and the confidence are output.

The initial detection boxes are sorted in descending order according to confidence, and recorded as Bₖ.

An average of a grid density covered by each of the detection boxes Bᵢ is computed as follows:

$${\overline{N}}_{i} = \frac{1}{\vert {G}_{ij} ⋂ {B}_{i} \vert} {Σ}_{{G}_{ij} ∈ {B}_{i}} {N}_{ij} ,$$

where Gᵢⱼ denotes the grid cells into which an image is divided; Bᵢ denotes an i-th initial detection box; and Nᵢⱼ denotes a density value of the grid cells Gᵢⱼ.

A ratio of a local density average N̅ᵢ to the global density average μ is used as an NMS threshold adjustment factor, an NMS threshold τ₀ is initialized based on the NMS threshold adjustment factor, and a dynamic NMS threshold τ₁ is generated, where the dynamic threshold is

$${τ}_{i} = {τ}_{0} \cdot \frac{{\overline{N}}_{i}}{μ} ,$$

μ denotes the global density average, and in the formula, τ₁ denotes the dynamically adjusted NMS threshold.

If an intersection of union of a detection box Bᵢ and a detection box Bⱼ is IoU(Bᵢ, Bⱼ)>τᵢ, the detection box having a higher density average is retained, the other box is deleted, and the step is repeated until all candidate boxes are processed; and detection results of the high-density zones are preferentially retained, and more candidate boxes are retained in the high-density zones to improve a recall rate of symbol detection.

Specifically, an improved density-weighted NMS algorithm solves a problem of over-suppression or missing detection of a conventional fixed NMS threshold caused by an uneven regional density in complex handwritten formulas by dynamically adjusting the threshold

$${τ}_{i} = {τ}_{0} \cdot \frac{{\overline{N}}_{i}}{μ} .$$

In a dense writing zone (N̅ᵢ>μ), the threshold τᵢ is raised to allow higher overlapping boxes to coexist and avoid false deletion of adjacent symbols (such as superscripts and subscripts).

In a sparse zone (N̅ᵢ>μ), the threshold τᵢ is lowered to reduce false detection.

A feature pyramid network (FPN) is constructed in the MobileNetV3-Small, and a low-level feature map C₃ and high-level feature maps C₄ and C₅ are fused:

Small-scale symbols are detected at a P₃ layer, and large-scale symbols are detected at a P₅ layer. Multi-scale symbol features are extracted through the feature pyramid network. That is, multi-scale symbol feature extraction is performed on zones including symbols (i.e. the detection boxes in the high-density zones) through the feature pyramid network, and a final symbol position and category are output.

Specifically, a backbone network of the MobileNetV3-Small outputs feature maps C₃ (shallow-layer high resolution), C₄ (middle layer) and C₅ (deep-layer low resolution) as input.

Through the feature pyramid network, C₃, C₄, and C₅ are subjected to cross-level fusion, and finally a multi-scale feature pyramid is output. P₃, P₄, and P₅ are used as output and correspond to different detection scales, respectively. At each level (P₃, P₄, and P₅), a YOLOv8-Nano detector head is deployed to predict a symbol of the corresponding scale.

3×3 convolution dimensionality reduction is performed on a deep feature C₅ to generate initial P₅ as follows:

P₅=Conv_{3×3}(C₅)

Upsampling is performed on P₅ to reach a size of C₄, and P₅ is added to a 1×1 convolution result of C₄ element by element, to generate P₄ as follows:

P₄=UpSample(P₅)⊕Conv_{1×1}(C₄)

Upsampling is performed on P₄ to reach a size of C₃, and P₄ is added to a 1×1 convolution result of C₃ element by element, to generate P₃ as follows:

P₃=UpSample(P₄)⊕Conv_{1×1}(C₃)

Then, a final feature pyramid is as follows:
P₃ indicates highest resolution (for example, ⅛) configured to detect small symbols (such as dots, left-falling strokes, and commas);
P₄ indicates medium resolution (for example, 1/16) configured to detect conventional symbols (such as letters and numbers); and
P₅ indicates lowest resolution (for example, 1/32) configured to detect large symbols (such as integral signs and fraction bars).

The YOLOv8-Nano detector heads predict the symbol position and category on P₃, P₄ and P₅. Each detector head generates a detection result through a convolution operation. The YOLOv8-Nano detector heads collect prediction results at all levels. Finally, the detection results are optimized through the improved density-weighted NMS algorithm, and a final symbol list is output.

Specifically, compared with using a conventional fixed NMS threshold, dynamic threshold adjustment based on a local/global density ratio preferably retains results of the high-density zones having high confidence, thus solving a problem that conventional methods are prone to missing detection in dense zones.

A handwriting grid density Nᵢⱼ is introduced, and complexity of symbol distribution is quantified by computing an average density of zones covered by the detection box. For example, an integral symbol may be accompanied by dense superscripts and subscripts, and a dynamic threshold can avoid false deletion of a key detection box.

In the embodiment, specific steps of the step that the stroke feature vector of the potential symbol zone is extracted through the MobileNetV3-Small model are as follows:

A symbol zone I_{crop} is cut from an original image according to detection box coordinates (x, y, w, h), and I_{crop} is preprocessed to obtain Iᵢₙₚᵤₜ.

I_{crop} is scaled to a fixed size (for example, 64×64 pixels) to generate a standardized image Iₙₒᵣₘ.

Iₙₒᵣₘ is converted into a single-channel gray image, and pixel value normalization is performed as follows:

$${I}_{input} = \frac{{I}_{norm} - μ}{σ}$$

In the formula, u denotes an average; σ denotes a standard deviation; and Iᵢₙₚᵤₜ denotes a standardized expression of a symbol zone as the only input of a feature extraction network.

According to stroke features (such as direction, curvature, and continuity) of handwritten symbols, direction-sensitive convolutions and a local attention mechanism are introduced into the MobileNetV3-Small to enhance an ability to capture stroke details.

Feature extraction is performed on Iᵢₙₚᵤₜ through the MobileNetV3-Small, and a deformable convolution is introduced into a Bottleneck layer of the MobileNetV3-Small. An offset Δpₖ and a direction angle θₖ of a convolutional kernel are dynamically learned, and a feature map F_{deform} of an adaptive stroke direction is obtained.

Network levels of the MobileNetV3-Small include an initial convolutional layer, a Bottleneck layer, a local stroke attention device, multi-level feature fusion, and global feature descriptor generation.

The initial convolutional layer is configured to perform initial feature extraction on Iᵢₙₚᵤₜ and generate a low-level feature map F₁ as follows:

F₁=Conv₃ₓ₃(Iᵢₙₚᵤₜ)

In the formula, F₁ denotes a low-level feature map output by the initial convolutional layer.

The Bottleneck layer is as follows:

The deformable convolution is introduced into the Bottleneck layer as follows:

$${F}_{deform} = {Σ}_{k = 1}^{K} {w}_{k} \cdot x ( p + {p}_{k} + Δ {p}_{k} ( {θ}_{k} ) )$$

Input is the low-level feature map F₁ generated by a previous layer.

In the formula, pₖ denotes an initial offset position of a fixed convolutional kernel; p denotes spatial position coordinates on the feature map; Δpₖ denotes a learnable offset; θₖ denotes a direction angle parameter, and the convolutional kernel is adapted to the stroke direction through gradient descent optimization; F_{deform} denotes a feature map of the adaptive stroke direction output by the deformable convolution, that is, output of the Bottleneck layer; K denotes a total quantity of convolutional kernels; k denotes an index variable; wₖ denotes a weight of the convolutional kernel, and parameters learned automatically through model training are configured to perform weighted summation on different positions on the input feature map; and x denotes input of the Bottleneck layer, that is, the low-level feature map F₁.

The local stroke attention device is as follows:

A stroke direction weight Aₛₜᵣₒₖₑ=σ(conv_{1×1}(GAP(F_{deform}))) is increased.

Thus, output of the local stroke attention device is as follows:

Fₐₜₜ=F_{deform}⊗σ(Aₛₜᵣₒₖₑ)

In the formula, GAP(*) denotes global average pooling; Conv_{1×1} denotes a 1×1 convolution operation; σ denotes a Sigmoid activation function, and is configured to map a weight value to a [0,1] interval; Aₛₜᵣₒₖₑ denotes an attention weight matrix of the stroke direction; ⊗ denotes element-by-element multiplication; and Fₐₜₜ denotes a feature map after attention enhancement.

Multi-level feature fusion is as follows:
Feature maps {F₃, F₆, F₁₂} are extracted from 3rd, 6th and 12th Bottleneck layers of MobileNetV3-Small and fused.

F_{fuse}=UpSample(F₁₂)⊕Conv_{1×1}(F₆)⊕Conv₁ₓ₁(F₃)

In the formula, F₃ denotes output of the 3rd Bottleneck layer; F₆ denotes output of the 6th Bottleneck layer; F₁₂ denotes output of the 12th Bottleneck layer; UpSample denotes an upsampling operation (such as bilinear interpolation); F_{fuse} denotes a fused multi-scale feature map; and ⊗ denotes element-by-element addition for feature fusion.

The global feature descriptor generation is as follows:

vₛₜᵣₒₖₑ=FC₅₁₂(GAP(F_{fuse}))

In the formula, GAP(*) denotes global average pooling; FC₅₁₂(*) denotes a 512-dimensional fully connected layer; and stroke denotes a non-normalized stroke feature vector.

L2 normalization is performed on the feature vector to generate a final stroke feature vector vₙₒᵣₘ as follows:

$${v}_{norm} = \frac{{v}_{stroke}}{{‖ {v}_{stroke} ‖}_{2}}$$

In the formula, ∥vₛₜᵣₒₖₑ∥₂ denotes a L2 norm, and is configured to compute a magnitude of the vector; and vₙₒᵣₘ denotes the normalized stroke feature vector.

In the embodiment, a binary feature pyramid is constructed in the MobileNetV3-Small, and integrates syntactic features of different levels. For example, a shallow feature C₃ retains stroke details (such as dots and left-falling strokes), and a deep feature C₅ captures structure information (such as fractions and radical signs). In this way, a problem of a large scale difference of handwritten formulas is solved.

The local stroke attention device is embedded in the feature pyramid network (FPN), and the stroke direction weight Aₛₜᵣₒₖₑ is added to the local stroke attention device. Key zones such as stroke intersection points and symbol connections are preferably focused on. For example, morphological differences between handwriting a and a may be effectively distinguished.

S3, a symbolic relationship graph is constructed through the extracted stroke feature vector vₙₒᵣₘ, and a node connection weight of the symbolic relationship graph is dynamically corrected based on a graph neural network or Transformer, which is configured to construct a two-dimensional spatial relationship of superscripts and subscripts, fractions, and integral structures.

In the embodiment, specific steps involved in the step that the symbolic relationship graph is constructed through the stroke feature vector vₙₒᵣₘ are as follows:

A relationship modeling device of the terminal of the artificial intelligence whiteboard fuses the handwriting pressure pₘ and the feature of the inclination angle θₘ in the extracted stroke feature vector vₙₒᵣₘ to obtain the fused stroke feature vector vₙₒᵣₘ. The handwriting pressure pₘ and the inclination angle θₘ are used as complementary dimensions of the stroke feature vector vₙₒᵣₘ, and are configured to improve a modeling ability of physical characteristics (such as a chalk inclination angle and a pen pressure change) of a writing tool, so as to distinguish symbols (such as “6” and “9”) having similar shapes and different writing dynamics. The handwriting pressure pₘ and the inclination angle θₘ need to be normalized to ensure the scale consistency of the feature vector and avoid a weight deviation caused by a physical dimension difference. v′ₙₒᵣₘ=Concat(vₙₒᵣₘ, pₘ, θₘ). In the formula, Concat(*) denotes a splicing operation along a feature dimension.

An adjacency matrix W is constructed based on the fused stroke feature vector v′ₙₒᵣₘ.

For each node uᵢ, a feature vector

$${v}_{norm}^{′ i}$$

of the node is defined as follows:

$${v}_{norm}^{′ i} ∈ {ℝ}^{d + 2}$$

In addition, the feature vector

$${v}_{norm}^{′ i}$$

of the node uᵢ is formed by fusing the stroke feature vector v_{norm,i} with the handwriting pressure p_{m,i} and the inclination angle θ_{m,i}.

An importance weight of each node uᵢ is initialized, and the handwriting pressure

$${p}_{m}^{( i )}$$

is normalized through the Sigmoid function as follows:

$${w}_{i} = σ ( {p}_{m}^{( i )} )$$

The inclination angle

$${θ}_{m}^{( i )}$$

is discretized into 8-direction codes as follows:
φᵢ∈

[symbol]

In the formula,

$${p}_{m}^{( i )}$$

denotes handwriting pressure of an i-th node; σ(*) denotes the Sigmoid function, and is configured to map a pressure value into one normalized weight range; w_{c} denotes an initial importance weight of a c-th node, and reflects magnitude information of the node during writing;

$$v {\text{?}}_{norm}$$

$$\text{?} \text{indicates text missing or illegible when filed}$$

denotes a complete feature vector of the i-th node, which combines syntactic and physical attributes, and a total dimension of the feature vector is d+2; φᵢ denotes tip inclination angle information of the i-th node; and [symbol] indicates that a continuous inclination angle θₘ is discretized into codes in 8 directions (for example, upward, downward, leftward, rightward, and diagonal directions), which is represented by an 8-dimensional vector.

For any two nodes, a center distance between circumscribed rectangles of the two nodes is defined as follows:

dᵢⱼ=∥(xᵢ, yᵢ)−(xᵢ, yᵢ)∥₂

In the formula, dᵢⱼ denotes an Euclidean distance between centers of circumscribed rectangles corresponding to a node i and a node j; and (xᵢ, yⱼ) denotes center coordinates of a rectangle of the i-th node.

According to differences of node sizes and features, the dynamic adjacency threshold is defined as follows:

$${γ}_{ij} = α \cdot max ( {w}_{i} , {h}_{i} , {w}_{j} , {h}_{j} ) + β \cdot ( 1 - sin ( {v}_{norm}^{′ ( i )} , {v}_{norm}^{′ ( j )} ) )$$

In the formula, yᵢⱼ denotes the dynamic adjacency threshold of a node pair i and j; a denotes a weight coefficient for balancing spatial scale influence; β denotes a weight coefficient for balancing feature difference influence; max (wᵢ, hᵢ, wⱼ, hⱼ) denotes a larger one of the node i and the node j, and is configured to describe a spatial scale; sim(*) denotes cosine similarity, and is configured to measure a scale of a fused feature vector v′ₙₒᵣₘ of the two nodes; wᵢ denotes a width of a circumscribed rectangle of the i-th node; and hᵢ denotes a height of the circumscribed rectangle of the i-th node. Similarly, wⱼ denotes a width of a circumscribed rectangle of the j-th node; and hⱼ denotes a height of the circumscribed rectangle of the j-th node.

If dᵢⱼ<yᵢⱼ, a basic connection is established between the node uᵢ and the node uⱼ.

An inclination angle difference Δθᵢⱼ of the inclination angle θₘ is computed as follows:

$$Δ {θ}_{ij} = \vert {θ}_{m}^{( i )} - {θ}_{m}^{( j )} \vert$$

If Δθᵢⱼ<0ₜₕ, it is considered that writing directions are consistent, and a weight of an edge is enhanced.

$${θ}_{m}^{( i )}$$

denotes a tip inclination angle of the i-th node;

$${θ}_{m}^{( j )}$$

denotes a tip inclination angle of the j-th node; and Δθᵢⱼ denotes an absolute difference between the tip inclination angles of the node i and the node j. If the difference is less than a set threshold θₜₕ, it is considered that the writing directions of the two nodes are consistent, such that the edge weight is enhanced.

Based on the fused stroke feature vector V norm, the direction codes and the inclination angle difference Δθᵢⱼ, an edge weight

$${w}_{ij}^{( 0 )}$$

of each pair or connection nodes (i, j) is initialized as follows:

$${w}_{ij}^{( 0 )} = σ ( {W}_{init} \cdot [ Concat ( {v}_{norm}^{′ ( i )} , {v}_{norm}^{′ ( j )} ) ⊕ {ϕ}_{ij} ⊕ {Δθ}_{ij} ] )$$

In the formula,

$${w}_{ij}^{( 0 )}$$

denotes an initial weight between the node i and the node j;

$$Concat ( {v}_{norm}^{′ ( i )} , {v}_{norm}^{′ ( j )} )$$

indicates that the fused feature vector of the two nodes is cascaded to obtain a higher-dimensional joint feature expression; φᵢⱼ denotes a joint direction encoding vector generated by direction codes of the node i and the node j (or direction information of a relationship of the two nodes), and reflects relative directions (such as “upper right” and “lower left”) of the two nodes; ⊕ denotes element-by-element addition, and is configured to fuse feature information (a joint feature, the direction codes and the inclination angle difference) from different sources; Wᵢₙᵢₜ denotes a learnable weight matrix, and is configured to linearly transform the fused features, to generate appropriate edge weights; and σ(*) denotes the Sigmoid activation function.

The edge weights of all the nodes (i, j) are collected, and an adjacency matrix (N denotes a quantity of nodes) of N×N is constructed and defined as follows:

If a spatial connection condition or feature similarity condition is satisfied,

$${W}_{ij} = {w}_{ij}^{( 0 )} .$$

If not, Wᵢⱼ=0.

The spatial connection condition is dᵢⱼ<yᵢⱼ, and the feature similarity condition is

$$sim ( {v}_{norm}^{′ ( i )} , {v}_{norm}^{′ ( j )} ) > η .$$

Specifically, Wᵢⱼ denotes whether the node i is connected to the node j and a connection weight; and n denotes a feature similarity threshold. When similarity is greater than the threshold, it is considered that the two nodes are similar enough in features to establish a connection.

$$sim ( {v}_{norm}^{′ ( i )} , {v}_{norm}^{′ ( j )} )$$

denotes cosine similarity between the fused feature vectors of the node i and the node j, and is configured to measure whether the two nodes are similar in syntactics.

Specific steps of the step that the node connection weight of the symbolic relationship graph is dynamically corrected through Transformer are as follows:

Before the adjacency matrix W is constructed, self-attention encoding is performed on the fused features of the nodes based on a Transformer encoder, and a context-sensitive expression zᵢ is obtained as follows:

$${z}_{i} = {\sum }_{j = 1}^{N} softmax ( \frac{{q}_{i} \cdot {K}_{j}^{T}}{\sqrt{{d}_{k}}} ) {V}_{j}$$

In the formula, zᵢ denotes the context-sensitive expression obtained by the i-th node through a self-attention mechanism, and is a result of weighted summation of all node information; qᵢ denotes a query vector of the i-th node; dk denotes a dimension of a key vector (or a query vector), and is used as a scaling factor to prevent an excessive dot product result from affecting a gradient of softmax; N denotes a quantity of elements in an input sequence, that is, a total quantity of nodes; Vⱼ denotes a value vector of the j-th node; Kⱼ denotes a key vector of the j-th node, and

$${K}_{j}^{T}$$

denotes transposition of the key vector of the j-th node; and j denotes an index variable.

A joint feature vector hᵢⱼ is constructed for any node pair (i, j).

The joint feature vector hᵢⱼ is constructed for each pair of nodes i and j as follows:

hᵢⱼ=concat(zᵢ, zⱼ, |zᵢ−zⱼ|, zᵢ⊙zⱼ)∈

[symbol]

In the formula, zᵢ denotes a context-sensitive feature vector of the node i encoded by a Transformer self-attention mechanism; zⱼ denotes a context-sensitive feature vector of the node j encoded by the Transformer self-attention mechanism; d′ denotes a dimension of the context-sensitive feature vector zᵢ of each node; zᵢ⊙zⱼ denotes a element-by-element product of the feature vectors of the node i and the node j; and zᵢ−zⱼ denotes a element-by-element difference of the feature vectors of the node i and the node j.

A multi-layer perceptron (MLP) classification device is introduced to classify the joint feature vectors hⱼ, and a correction factor τᵢⱼ is predicted.

A multi-layer perceptron (MLP) is used as the classification device, and is configured to process the joint feature vector hᵢⱼ and output the correction factor τᵢⱼ corresponding to a node pair (i, j) as follows:

τᵢⱼ=f(hᵢⱼ)=σ(W₂ReLU(W₁hᵢⱼ+b₁)+b₂)

In addition, W₁∈ [symbol] denotes a weight matrix of a first layer of the MLP; b₁∈ [symbol] denotes a biased vector of the first layer of the MLP; b₂∈ [symbol] denotes a biased scalar of a second layer of the MLP; w₂∈ [symbol] denotes a weight matrix of the second layer of the MLP, and is configured to map output of a hidden layer to the correction factor τᵢⱼ; ReLU(*) denotes a nonlinear activation function; and σ(*) denotes the Sigmoid function.

The dynamic adjacency threshold yᵢⱼ is updated based on the correction factor τᵢⱼ, and finally whether to establish a connection in the adjacency matrix W is determined according to the updated dynamic adjacency threshold

$${γ}_{ij}^{*} .$$

Through a strategy of correction with context information, the threshold is updated as follows:

$${γ}_{ij}^{*} = {γ}_{ij} + λ \cdot {τ}_{ij}$$

In the formula, λ denotes an adjustable weight factor, and is configured to balance contributions of an original threshold and the correction factor; and

$${γ}_{ij}^{*}$$

denotes the updated dynamic adjacency threshold.

Finally, according to a center distance di between circumscribed rectangles of the node pair, a final adjacency matrix W is constructed.

Thus, after optimization, if the spatial connection condition or feature similarity condition is satisfied,

$${W}_{ij} = {w}_{ij}^{( 0 )} .$$

If not, Wᵢⱼ=0.

The spatial connection condition is dᵢⱼ<yᵢⱼ, and the feature similarity condition is

$$sim ( {v}_{norm}^{′ ( i )} , {v}_{norm}^{′ ( j )} ) > η .$$

η denotes a feature similarity threshold, and is configured to determine syntactic association strength between nodes.

In the embodiment, the final adjacency matrix W encodes all structure information of the symbolic relationship graph, and the dynamic nature of the adjacency matrix makes the symbolic relationship graph adapt to writing changes of complex formulas. The adjacency matrix W is a mathematical expression of the symbolic relationship graph.

The symbolic relationship graph provides a directly parseable topological structure for subsequent syntax tree construction and LaTeX generation.
S4, based on a node feature and a dynamic adjacency matrix in the symbolic relationship graph, an initial LaTeX sequence is generated through a Transformer decoder, the initial LaTeX sequence is dynamically planned through a Cocke-Younger-Kasami (CYK) algorithm, and the symbolic relationship graph is transformed into a LaTeX expression.

A syntax parsing device of the terminal of the artificial intelligence whiteboard predicts a syntactic role r; of each symbol node based on node features of the symbolic relationship graph and the multi-layer perceptron. The syntax structure tree is constructed by combining the final adjacency matrix W, and the syntax tree is encoded from bottom to top through a tree-structured long short-term memory.

In the embodiment, for each node vᵢ in the symbolic relationship graph, a syntactic role rᵢ is predicted through a multi-layer perceptron (MLP) as follows:

rᵢ=MPL(v′ₙₒᵣₘ)

In the formula, rᵢ denotes a predicted syntactic role of a node vᵢ; and MPL denotes a multi-layer perceptron.

Based on the final adjacency matrix W and the syntactic role rᵢ, a syntax structure tree is constructed.

Based on the updated dynamic adjacency threshold

$${γ}_{ij}^{*} ,$$

and a parent-child relationship is determined by breadth-first search.

The syntax structure tree is encoded from bottom to top through a tree-structured long short-term memory.

For each node vᵢ of the syntax tree, child node features are aggregated to generate a hidden state k; as follows:

kᵢ=TreeLSTM(rᵢ, {h_{c}|c∈children(i)})

In the formula, TreeLSTM(*) denotes a long short-term memory (LSTM) unit of the tree-structured long short-term memory, and aggregates subtree information from bottom to top; kᵢ denotes a hidden state of the node vᵢ and encodes a syntactic role and a child node feature of the node; and h_{c} denotes a hidden state of a child node c.

The Transformer decoder generates a Token sequence based on syntax tree encoding H={kᵢ}.

Meanwhile, relative coordinate differences Δxᵢⱼ and Δyᵢⱼ between symbols are introduced, and are mapped into embedded vectors and added to an attention score as follows:

$$Attention ( Q , K , V ) = Softmax ( \frac{{QK}^{T} + R ( Δ {x}_{ij} , Δ {y}_{ij} )}{\sqrt{d}} ) V$$

Δxᵢⱼ=xⱼ−xᵢ denotes a horizontal coordinate difference between nodes vⱼ and vᵢ; and Δyᵢⱼ=yⱼ−yᵢ denotes a longitudinal coordinate difference between nodes vⱼ and vᵢ.

In the formula, Q denotes an “attention demand” of a currently required target position (such as a LaTeX token being decoded) for an input symbol; K denotes a “feature index” of the input symbol (a node in the symbolic relationship graph); V denotes actual feature information of the input symbols, and is configured to generate target output after weighted aggregation; Attention (Q, K, V) denotes a core input matrix that generates an attention score; QK^{T} denotes computation of similarity (an original attention weight) between query and a key; R(*) denotes a learnable function that maps coordinate differences into attention bias terms; and d denotes a dimension of a key vector.

The attention score is a weight value computed based on similarity between Q and K, and indicates importance of an input symbol to a current target position.

Further, in a decoding process of the Transformer decoder, relative position codes between symbols are introduced to adjust attention scores.

Spatial constraints (in distance, direction, and adjacency weight) are encoded into grammatical rule scores.

For each candidate rule A′→B′ C′, a spatial score function is defined as follows:

S(B′, C′, A′)=exp(−λ_{d}·l(B′,C′))·cos(θ(B′, C′)−w_{B′C′}

In the formula, l(B′, G′) denotes an Euclidean distance between the symbols B′ and C′; θ(B′, C′) denotes a direction angle of the symbols B′ and C′; θ_{A} denotes an ideal direction expected by a rule A′; w_{B′C′} denotes edge weights of B′ and C′ in the adjacency matrix; λ_{d} denotes a distance attenuation coefficient and controls spatial sensitivity; A′ denotes a symbol of a parent node; and B′, C′ both denote candidate child symbols.

In the CYK algorithm, the rules are dynamically planned and updated, and a weight of each cell C[A, i, j] is as follows:

$$C [ A , i , j ] = {max}_{B , C , k} [ P ( A \to BC ) \cdot S ( B , C , A ) \cdot C [ B , i , k ] \cdot C [ C , k + 1 , j ] ]$$

In the formula, P(A→BC) denotes a syntax rule probability; S(B, C, A) denotes a spatial score, and is configured to amplify the rule probability conforming to a spatial layout; C(A, i, j) denotes a maximum score of a non-termination symbol A covering input positions i to j, i denotes a starting position (a starting index of symbols in the symbolic relationship graph) of an input sequence, and j denotes an ending position (an ending index of the symbols in the symbolic relationship graph) of the input sequence; k denotes a division point; C(B, i, k) denotes a maximum score, that can be generated by the non-termination symbol B, of a subsequence from positions i to k; and A and B denote non-termination symbols (such as expressions, terms, and factors) in context-free grammar (CFG).

The initial LaTeX sequence is dynamically planned through the CYK algorithm, and the symbolic relationship graph is transformed into the LaTeX expression. The involved specific expression is as follows:

$$LaTeX = arg {max}_{ParseTree} {\sum }_{( A \to BC ) ∈ ParseTree} log P ( A \to BC ) + log S ( B , C , A )$$

In the formula, ParseTree denotes a parse tree conforming to a syntax rule and spatial constraints; log P(*) denotes a logarithmic probability of the syntax rule; and log S(*) denotes a logarithmic term of the spatial score, and is configured to amplify a rule of a rational layout.

Embodiment 2: The embodiment provides an artificial intelligence based system for identifying a formula handwritten on a whiteboard in real time. The system includes a memory, a processor, and a computer program stored in the memory and runnable on the processor. The processor executes the computer program to implement the steps of the artificial intelligence based method for identifying a formula handwritten on a whiteboard in real time according to any one of the embodiments.

The above description shows and describes basic principles, essential features and advantages of the present disclosure. Those skilled in the art should understand that the present disclosure is not limited by the above embodiments, the above embodiments and the description only illustrate preferred examples of the present disclosure instead of limiting the present disclosure, various changes and improvements can be made to the present disclosure without departing from the spirit and scope of the present disclosure, and these changes and improvements all fall within the claimed scope of the present disclosure. The claimed protection scope of the present disclosure is defined by the appended claims and their equivalents.

1. An artificial intelligence based method for identifying a formula handwritten on a whiteboard in real time, comprising the following steps:
S1, capturing a touch point sequence input by a user through an artificial intelligence whiteboard, constructing a handwriting path trajectory rᵢ(t) based on the touch point sequence, and delineating a high-density handwriting zone;
S2, performing symbol detection on the high-density handwriting zone to locate a potential symbol zone, and extracting a stroke feature vector vₙₒᵣₘ of the potential symbol zone through a MobileNet Version 3 Small (MobileNetV3-Small) model;
S3, fusing the extracted stroke feature vector vₙₒᵣₘ with handwriting pressure pₘ and a feature of an inclination angle θₘ, constructing a symbolic relationship graph, and dynamically correcting a node connection weight of the symbolic relationship graph through Transformer combined with a multi-layer perceptron (MLP) classification device, wherein
specific steps involved in constructing the symbolic relationship graph through the stroke feature vector vₙₒᵣₘ are as follows:
fusing the handwriting pressure pₘ and the feature of the inclination angle θₘ with the stroke feature vector vₙₒᵣₘ, and obtaining the fused stroke feature vector v′ norm;
initializing an importance weight w_{c} for the handwriting pressure pₘ;
discretizing the inclination angle θₘ into 8-direction codes φᵢ∈ [symbol] ;
computing, for any two nodes, a center distance dᵢⱼ between circumscribed rectangles of the two nodes, and defining a dynamic adjacency threshold γᵢⱼ:
$${γ}_{ij} = α \cdot max ( {w}_{i} , {h}_{i} , {w}_{j} , {h}_{j} ) + β \cdot ( 1 - sim ( {v}_{norm}^{′ ( i )} , {v}_{norm}^{′ ( j )} ) )$$
in the formula, γᵢⱼ denotes the dynamic adjacency threshold of a node pair i and j; α denotes a weight coefficient for balancing spatial scale influence; β denotes a weight coefficient for balancing feature difference influence; sim(*) denotes cosine similarity; wᵢ denotes a width of a circumscribed rectangle of an i-th node; hᵢ denotes a height of the circumscribed rectangle of the i-th node; wⱼ denotes a width of a circumscribed rectangle of a j-th node; and hⱼ denotes a height of the circumscribed rectangle of the j-th node;
computing an inclination angle difference Δθᵢⱼ of the inclination angle θₘ;
initializing, based on the fused stroke feature vector v′ₙₒᵣₘ, the 8-direction codes φᵢ and the inclination angle difference Δθᵢⱼ, an edge weight
$${w}_{ij}^{( 0 )}$$
of each pair of connection nodes (i, j); and
collecting the edge weights of all the nodes (i, j), and constructing an adjacency matrix W of N×N; and
S4, generating, based on a node feature and a dynamic adjacency matrix in the symbolic relationship graph, an initial LaTeX sequence through a Transformer decoder, dynamically planning the initial LaTeX sequence through a Cocke-Younger-Kasami (CYK) algorithm, and transforming the symbolic relationship graph into a LaTeX expression.

2. The artificial intelligence based method for identifying a formula handwritten on a whiteboard in real time according to claim 1, wherein in S1, specific steps of the delineating a high-density handwriting zone are as follows:
S1.1, combining the handwriting pressure pₘ and the inclination angle θₘ, and discretizing the handwriting path trajectory rᵢ(t) into a dense point sequence
$${q}_{m}^{( i )} ;$$
S1.2, merging an original touch point sequence S and the dense point sequence
$${q}_{m}^{( i )} ,$$
generating an enhanced point set S′, and computing a grid density Nᵢⱼ; and
S1.3, performing dynamic threshold segmentation on the grid density Nᵢⱼ, and delineating the high-density handwriting zone.

3. The artificial intelligence based method for identifying a formula handwritten on a whiteboard in real time according to claim 2, wherein in S1.3, specific steps of the delineating the high-density handwriting zone are as follows:
counting a global density average μ of all non-empty grid cells Gᵢⱼ;
computing a standard deviation σ of density distribution based on the global density average μ;
using a linear combination of the global density average μ and the standard deviation σ as a dynamic density threshold θ;
traversing all the grid cells Gᵢⱼ, labeling, if Nᵢⱼ≥0, the grid cells Gᵢⱼ as high-density zones, and generating a candidate set [symbol] ={Gᵢⱼ|Nᵢⱼ≥θ};
modeling the high-density candidate set [symbol] as a graph G;
traversing the graph G based on a breadth-first search algorithm, and merging adjacent high-density grids into connected zones [symbol] ; and
repeating a process of traversing the graph G through the breadth-first search algorithm, wherein each time of the process starts from an unprocessed starting point to generate a new connected zone, repeating the process until all the high-density grids are accessed, and finally generating m independent high-density handwriting zone sets K.

4. The artificial intelligence based method for identifying a formula handwritten on a whiteboard in real time according to claim 3, wherein in S2, specific steps of the performing symbol detection on the high-density handwriting zone to locate a potential symbol zone are as follows:
computing center coordinates (x_{c}, y_{c}) and a width and height (w, h) of a circumscribed rectangle of each of the connected zones [symbol] in the high-density handwriting zone set K, and generating a multi-scale candidate box set
$$\{ {B}_{ℓ}^{( s )} \} ;$$
using the multi-scale candidate box set
$$\{ {B}_{ℓ}^{( s )} \}$$
as input of You Only Look Once Version 8 Nano (YOLOv8-Nano), and outputting initial detection boxes through the YOLOv8-Nano;
sorting the initial detection boxes in descending order according to confidence, and obtaining an ordered list {Bₖ};
computing an average N̅ᵢ of a grid density covered by each of the detection boxes Bᵢ;
using a ratio of a local density average N̅ᵢ to the global density average μ as a non-maximum suppression (NMS) threshold adjustment factor, initializing an NMS threshold τ₀ based on the NMS threshold adjustment factor, and generating a dynamic NMS threshold τᵢ;
retaining, if an intersection of union of a detection box Bᵢ and a detection box Bⱼ is IoU(Bⱼ, Bⱼ)>τᵢ, the detection box having a higher density average, deleting the other box, and repeating the step until all candidate boxes are processed; and
constructing a feature pyramid network in MobileNetV3-Small, performing multi-scale symbol feature extraction on the detection boxes in the high-density zones through the feature pyramid network, and outputting a final symbol position and category.

5. The artificial intelligence based method for identifying a formula handwritten on a whiteboard in real time according to claim 4, wherein in S2, specific steps of the extracting a stroke feature vector of the potential symbol zone through a MobileNetV3-Small model are as follows:
cutting a symbol zone I_{crop} from an original image according to detection box coordinates (x, y, w, h), and preprocessing I_{crop} to obtain Iᵢₙₚᵤₜ;
introducing a deformable convolution into a Bottleneck layer of the MobileNetV3-Small, dynamically learning an offset Δpₖ and a direction angle θₖ of a convolutional kernel, and obtaining a feature map F_{deform} of an adaptive stroke direction;
inputting the feature map F_{deform} as a local stroke attention device of the MobileNetV3-Small, adding a stroke direction weight Aₛₜᵣₒₖₑ to the local stroke attention device, and obtaining a feature map Fₐₜₜ of a key stroke zone;
performing cross-level feature fusion on feature maps extracted from different Bottleneck layers, and obtaining a fused multi-scale feature map F_{fuse}; and
performing dimensionality reduction on the multi-scale feature map F_{fuse}, and generating the stroke feature vector vₙₒᵣₘ.

6. The artificial intelligence based method for identifying a formula handwritten on a whiteboard in real time according to claim 1, wherein specific steps of the dynamically correcting a node connection weight of the symbolic relationship graph through Transformer combined with an MLP classification device are as follows:
performing, before constructing the adjacency matrix W, self-attention encoding on the stroke feature vector v′ₙₒᵣₘ based on a Transformer encoder, and obtaining a context-sensitive expression zᵢ;
constructing a joint feature vector hᵢⱼ for any node pair (i, j);
introducing the MLP classification device to classify the joint feature vectors hᵢⱼ, and obtaining a predicted correction factor τᵢⱼ; and
updating the dynamic adjacency threshold γᵢⱼ based on the correction factor τᵢⱼ, and finally determining whether to establish a connection in the adjacency matrix W according to the updated dynamic adjacency threshold
$${γ}_{ij}^{*}$$

7. The artificial intelligence based method for identifying a formula handwritten on a whiteboard in real time according to claim 6, wherein S4 comprises: predicting, for each node vᵢ in the symbolic relationship graph, a syntactic role rᵢ based on a multi-layer perceptron;
constructing, based on the final adjacency matrix W and the syntactic role rᵢ, a syntax structure tree;
encoding the syntax structure tree from bottom to top through a tree-structured long short-term memory;
generating, by the Transformer decoder, a LaTeX sequence through an autoregressive method, wherein each step predicts a next Token based on syntax tree encoding and an attention mechanism;
introducing, in a decoding process of the Transformer decoder, relative position codes between symbols to adjust attention scores; and
dynamically planning the initial LaTeX sequence through the CYK algorithm, and transforming the symbolic relationship graph into the LaTeX expression.

8. An artificial intelligence based system for identifying a formula handwritten on a whiteboard in real time, comprising a memory, a processor, and a computer program stored in the memory and runnable on the processor, wherein the processor executes the computer program to implement the steps of the artificial intelligence based method for identifying a formula handwritten on a whiteboard in real time according to any one of claims 1 to 7.
